(19) United States
(12) Patent Application Publication
(10) Pub. No.: US 2013/0199807 A1
(43) Pub. Date: Aug. 8, 2013

(54) Tillage System with Interchangeable Modules

(71) Applicants: Mark Hoffman, Tulare, CA (US); Kevin G. McDonald, Kingsburg, CA (US)

(72) Inventors: Mark Hoffman, Tulare, CA (US); Kevin G. McDonald, Kingsburg, CA (US)

(21) Appl. No.: 13/758,896

(22) Filed: Feb. 4, 2013

Related U.S. Application Data
(60) Provisional application No. 61/594,995, filed on Feb. 3, 2012.
(60) Provisional application No. 61/598,279, filed on Feb. 13, 2012.

(51) Int. Cl. A01B 49/02; A01B 63/16; A01B 35/16; A01B 5/04; A01B 3/24

(52) U.S. Cl. CPC A01B 49/027; A01B 5/04; A01B 3/24; A01B 35/16; A01B 63/16
USPC 172/1; 172/518; 172/681; 172/668; 172/149; 172/140

(57) ABSTRACT

A reconfigurable farm implement for tilling soil is described. The farm implement may comprise a frame having a plurality of mounting surfaces. A plurality of interchangeable tillage modules may be releasably coupled to the mounting surfaces. The interchangeable tillage modules may be arranged in a predetermined order based on a tillage requirement.

### CROSS-REFERENCE TO RELATED APPLICATIONS

The present application claims priority to provisional U.S. Patent Application Ser. No. 61/594,995, filed on Feb. 3, 2012, titled “One Pass Tillage,” and provisional U.S. Patent Application Ser. No. 61/598,279, filed on Feb. 13, 2012, titled “Modular Tillage System and Method,” which are hereby incorporated by reference in their entirety.

### FIELD OF THE INVENTION

The present invention relates generally to farm implements and more specifically to tillage systems.

### BACKGROUND

Tillage is the process of preparing soil for the raising of crops, and in its broadest sense involves mechanical agitation of the soil. Primary tilling typically involves deeper penetration of the soil and may produce a rough, clumpy surface. Secondary tilling is generally shallower than primary tilling and produces a smoother surface. Depending on specific tillage requirements, soil that has undergone primary tilling may subsequently be subject to secondary tilling to produce a desire surface texture that is conducive to the crop to be planted, or the machinery used to plant the crop.

A wide variety of implements have been developed for various stages of tilling. For example, the soil may first be worked with a disc implement to penetrate deeply into the soil and turn the disturbed soil over. This operation may produce large clods of soil, so a second pass may be made over the soil using tines or shanks to further break up and mix the soil. A third pass may be made with a reel implement with rotating blades that may further reduce the size of the soil clods. Finally, one or more rollers may be used to impart a desired surface texture to the soil.

During the growing season, previously tilled soil tends to compact. This compaction may be further aggravated during harvesting when heavy machinery passes through the field. In addition, the harvesting process tends to leave behind a residue of plant matter in the field. Tilling the soil helps to reduce compaction and aerate the soil, which is necessary to promote crop growth. Tilling may also serve to mix the residual plant matter into the soil where it can decompose, providing nutrients for the next crop.

### SUMMARY

The present application is directed to a reconfigurable farm implement for tilling soil. Various embodiments may comprise a frame having a plurality of mounting surfaces. A plurality of interchangeable tillage modules may be releasably coupled to the mounting surfaces. The interchangeable tillage modules may be arranged in a predetermined order based on a tillage requirement.

According to additional exemplary embodiments, the present application may be directed to methods for tilling soil. An exemplary method may comprise providing a frame and providing a plurality of mounting surfaces on the frame. A plurality of interchangeable tillage modules may be releasably coupled to the mounting surfaces. Tillage requirements may be analyzed to determine an arrangement of the interchangeable tillage modules.

### BRIEF DESCRIPTION OF THE DRAWINGS

FIG. 1 is a perspective view of a tillage system with frame wings according to various embodiments.

FIG. 2 is a perspective view of a tillage system with frame wings in a folded position according to various embodiments.

FIG. 3 is a side view of a tillage system with frame wings in a folded position according to various embodiments.

FIG. 4 is a side exploded view of a tillage system with frame wings in according to various embodiments.

FIG. 5 is a perspective view of a tillage system according to various embodiments.

FIG. 6 is a perspective view of a tillage system according to various embodiments.

FIG. 7 is a perspective view of a tillage system according to various embodiments.

FIG. 8 is a perspective view of a tillage system according to various embodiments.

FIG. 9 is a perspective view of a tillage module according to various embodiments.

FIG. 10 is a top view of a tillage module according to various embodiments.

FIG. 11 is a perspective view of a tillage module according to various embodiments.

FIG. 12 is a top view of a tillage module according to various embodiments.

FIG. 13 is a perspective view of a tillage module according to various embodiments.

FIG. 14 is a top view of a tillage module according to various embodiments.

FIG. 15 is a perspective view of a tillage module according to various embodiments.

FIG. 16 is a top view of a tillage module according to various embodiments.

FIG. 17 is an exemplary flow diagram of a method for tilling soil according to various embodiments.

### DETAILED DESCRIPTION

The present application is directed to a reconfigurable farm implement for tilling soil. Various embodiments may comprise a frame having a plurality of mounting surfaces. A plurality of interchangeable tillage modules may be releasably coupled to the mounting surfaces. The interchangeable tillage modules may be arranged in a predetermined order based on a tillage requirement.

According to additional exemplary embodiments, the present application may be directed to methods for tilling soil. An exemplary method may comprise providing a frame and providing a plurality of mounting surfaces on the frame. A plurality of interchangeable tillage modules may be releasably coupled to the mounting surfaces. Tillage requirements may be analyzed to determine an arrangement of the interchangeable tillage modules.

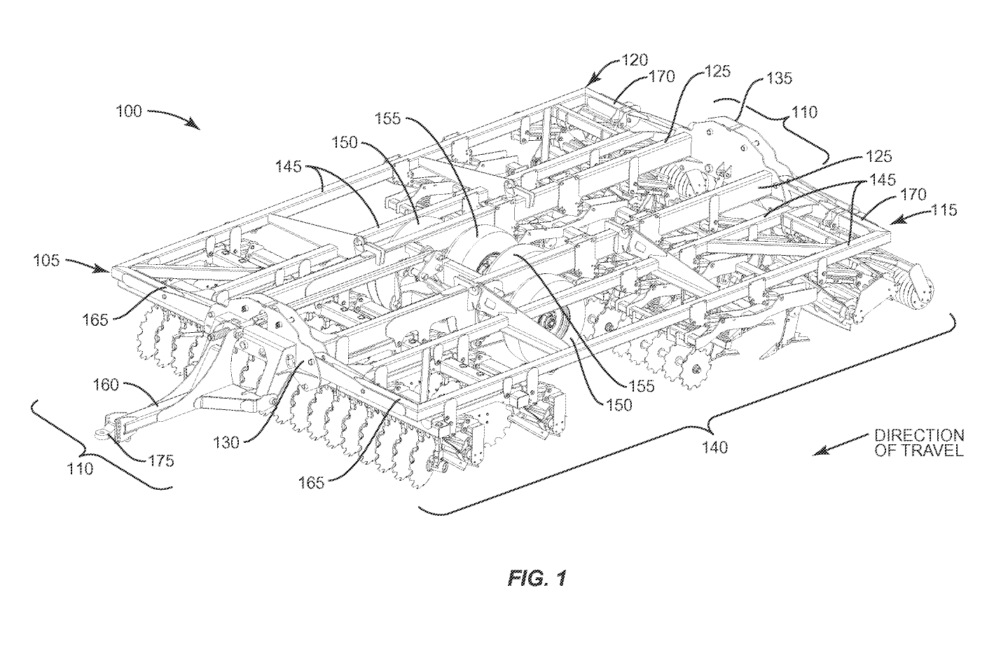

FIG. 1 illustrates a tillage system 100 according to various embodiments. The tillage system 100 may comprise a frame assembly generally designated by reference number 105. The frame assembly 105 may comprise a central frame support structure 110, left frame wing 115, and right frame wing 120. The central frame support structure 110 may comprise a plurality of central longitudinal support beams 125 arranged parallel to one another and generally equally spaced apart. The central longitudinal support beams may be oriented substantially in the direction of travel as shown by the arrow in FIG. 1. Front ends of the central longitudinal support beams 125 may be coupled to a front folding frame bracket 130. Similarly, back ends of the central longitudinal support beams 125 may be coupled to a rear folding frame bracket 135.

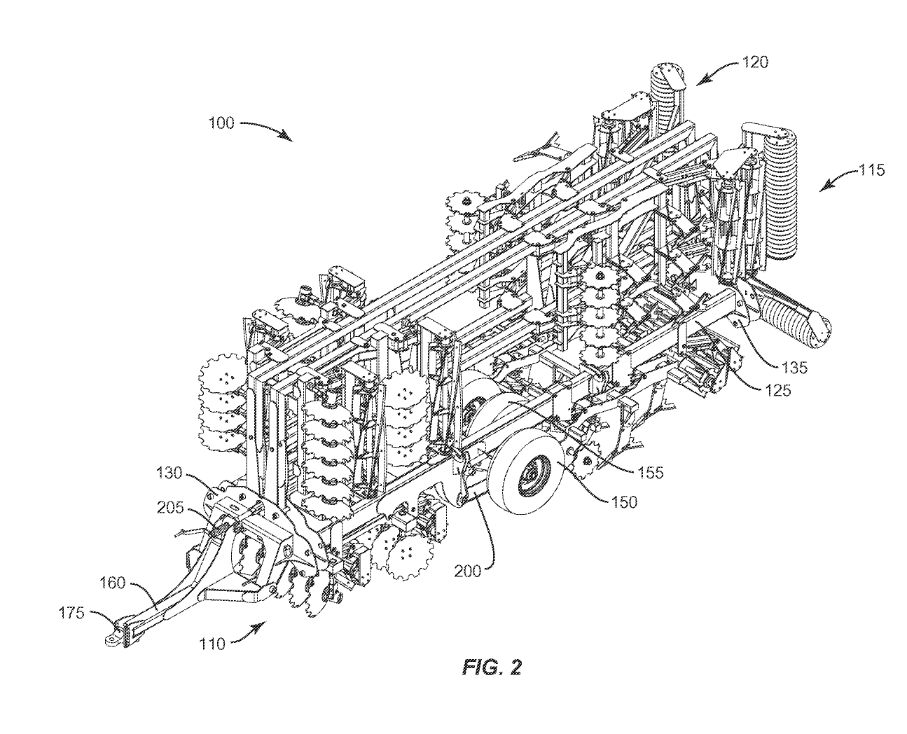

In various embodiments, the left and right frame wings 115, 120 may be located on opposite sides of the central frame support structure 110 and comprise frame wing longitudinal support beams 145. Front ends of the frame wing longitudinal support beams 145 may be coupled to frame wing front lateral support beams 165, and back ends of the frame wing longitudinal support beams 145 may be coupled to frame wing rear lateral support beams 170. An end of the frame wing front and rear lateral support beams 165, 170 may extend beyond the innermost frame wing longitudinal support beam 145 and pivotably couple with the front and rear folding frame brackets 130, 135, respectively. The frame assembly 105 may comprise a plurality of lateral support beams between the central longitudinal support beams 125 and frame wing longitudinal support beams 145 as necessary to provide structural support. Additionally, a plurality of tillage modules, generally indicated by reference number 140 and as further described below, may be releasably coupled to the frame assembly 105. According to various embodiments, one of the tillage modules 140 may comprise a depth and leveling control module comprising a pair of outer wheels 150 and a pair of inner wheels 155. As illustrated in FIG. 2, the depth and leveling control module may further comprise one or more actuators 200 that may be operative to raise or lower the frame assembly 105 relative to the outer and inner wheels 150, 155. A control linkage 205 may extend from the actuators to an outer edge of the frame assembly 105 to provide ready access for an operator.

In various embodiments, the frame assembly 105 may further comprise a hitch assembly 160 adapted to couple the tillage system 100 to a tractor or other vehicle to pull the tillage system 105 across the ground in the direction of travel. A terminal end 175 of the hitch assembly 160 may be adapted to couple to any corresponding hitch mechanism on the tractor or other vehicle known in the art now or in the future. The hitch assembly 160 may further comprise pneumatic or hydraulic connectors and tubing, or electrical connectors and wiring, as necessary to operate pneumatic, hydraulic, or electrical devices incorporated into the tillage system 100.

The cross-section shape, material of construction, and number of central longitudinal support beams 125, frame wing longitudinal support beams 145, frame wing lateral support beams 165, 170, and other lateral support beams may be selected according to engineering design principles known in the art to provide sufficient structural strength and ease of construction. In various embodiments, the longitudinal and lateral support beams may comprise a hollow rectangular cross-sectional shape. In other embodiments, a portion of the support beams may comprise a circular or oval cross-sectional shape. The longitudinal and lateral support beams may be coupled together by any fastener or fastening method known in the art or which may become known in the art such as bolts, pins, clamps, rivets, straps, welding, adhesive bonding, and the like.

FIG. 2 illustrates the operation of the left and right frame wings 115, 120 according to various embodiments. Each of the left and right frame wings 115, 120 may be moved from an operative position essentially parallel to the ground (see FIG. 1) to a storage position essentially perpendicular to the ground as illustrated in FIG. 2. The frame assembly 105 and left and right frame wings 115, 120 may include one or more locking mechanisms to retain the left and right frame wings 115, 120 in either the operative or storage position. Placing the left and right frame wings 115, 120 in the storage position may facilitate transporting and storing the tillage system 100 because of a reduced overall width. In various embodiments, the overall width in the storage position may not exceed 12 feet so that the tillage system 100 may be transported on public roads.

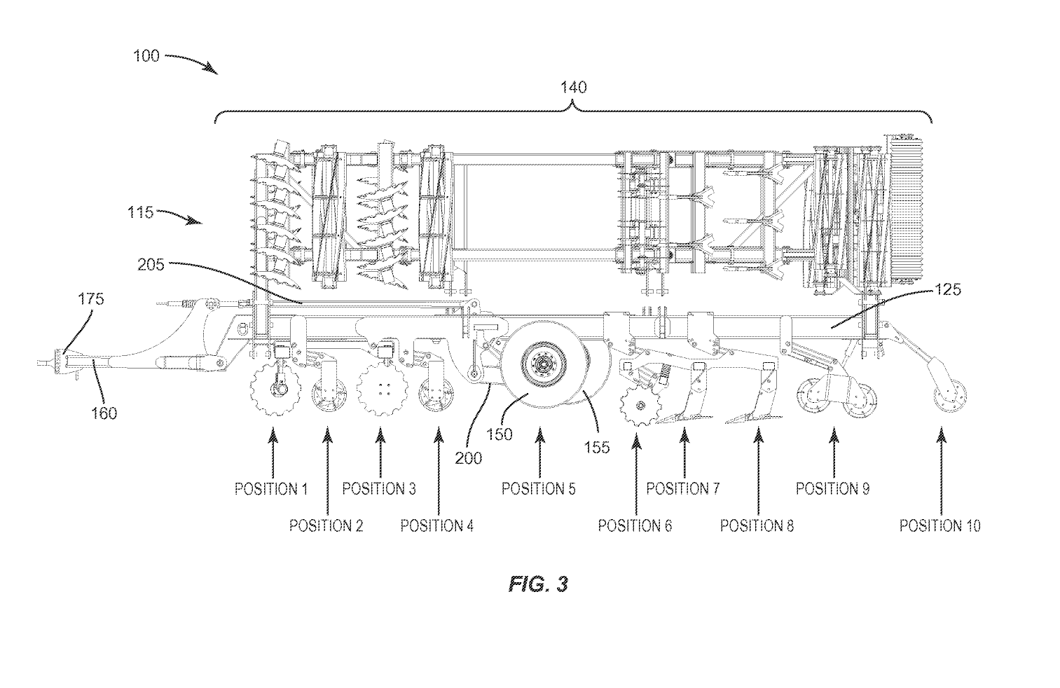

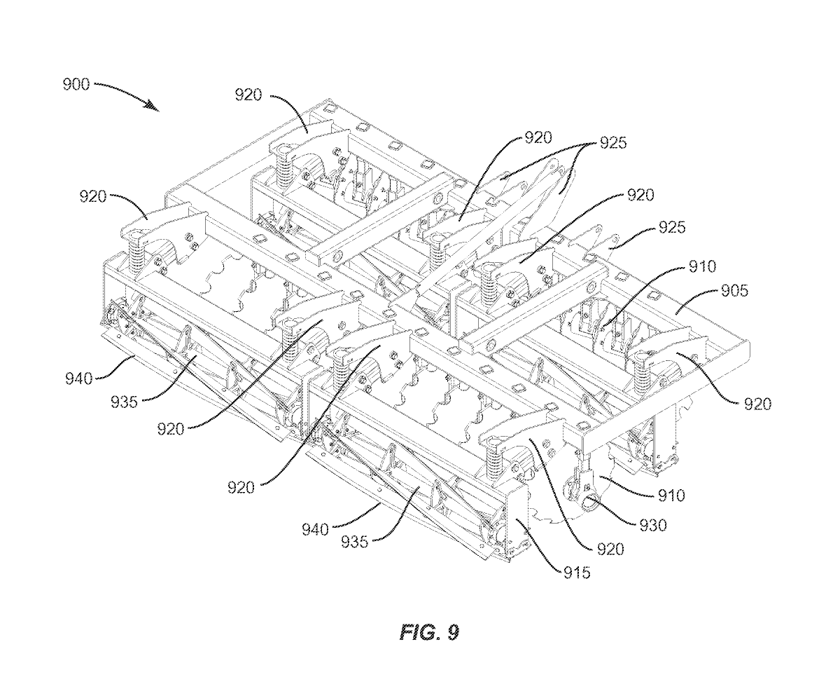

FIG. 3 illustrates a left side view of the tillage system 100 with the left frame wing 115 and the right frame wing 120 (not visible in this view) in the storage position according to various embodiments. In the embodiment shown, the tillage system 100 comprises ten rows (designated as Position 1 through Position 10 in FIG. 3) of modules 140 coupled to the frame assembly 105. Each of the modules 140 may comprise one or more tillage implements as discussed further for FIGS. 9 through 17. While FIG. 3 illustrates certain modules 140 in each of the Positions 1 through 10, any order of modules 140 may be assembled. As described below, each of the modules 140 share a common mounting arrangement to the frame assembly 105. Thus, the modules 140 may be disconnected and reconfigured (i.e., mounted to the frame assembly 105 in a different order) to accommodate specific tillage requirements.

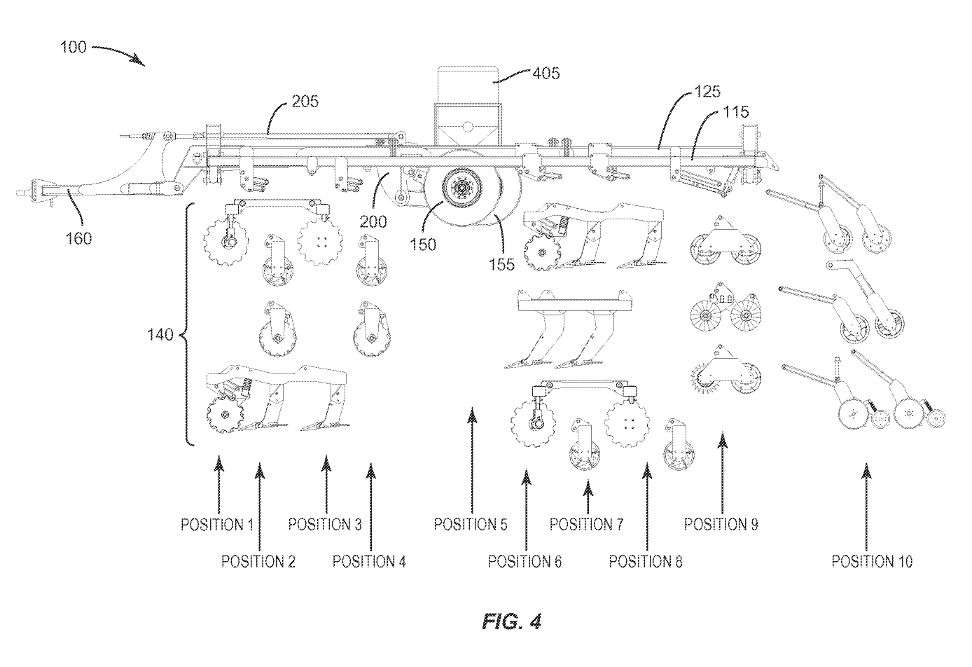

FIG. 4 illustrates a left side view of the tillage system 100 with the left frame wing 115 and the right frame wing 120 (not visible in this view) in the operative position according to various embodiments to exemplify the interchangeability of the modules 140. Below each of the Positions 1 through 10 are illustrated a variety of exemplary modules 140 that may be mounted at each Position. Essentially any module may be mounted at any of the Positions 1 through 10. The outer and inner wheels 150, 155 are shown in Position 5 which may provide proper balance of the tillage system 100. However, the outer and inner wheels 150, 155 may be positioned forward or rearward of Position 5 to suit the needs of any particular arrangement of modules 140.

FIG. 4 also illustrates an optional container system 405 coupled to the tillage system frame assembly 105 according to various embodiments. The container system 405 may comprise a fertilizer or herbicide tank and associated spraying equipment. Alternatively, the container system 405 may comprise a planter hopper and distribution equipment to sow seeds or insert seedlings into the soil. The container system 405 may apply any material on or into the soil as is known in the art and is not limited by the examples described herein. Although FIG. 4 illustrates the container system 405 positioned generally in the center of the tillage system frame assembly 105, the container system 405 may be placed at any position on the tillage frame system 105, including a side surface.

In order to facilitate the pivoting operation of the left and right frame wings 115, 120, each module 140 may be divided into three sections: a left module section that couples to the left frame wing 115, a center module section that couples to the central frame support structure 110, and a right module section that couples to the right frame wing 120. Therefore, it is possible to interchange modules 140 within a single Position 1 through 10. For example, FIG. 3 illustrates various embodiments in which Position 1 is occupied by disc modules and Position 2 is occupied by reel modules. It may be possible to mount a basket module at the center section of Position 1 while maintaining disc modules at the left and right sections (or any other combination of modules at the left, center, and right sections). In order to produce a uniform tillage across a width of the tillage system 100, the same module may be mounted at each of the three section of any given Position 1 through 10.

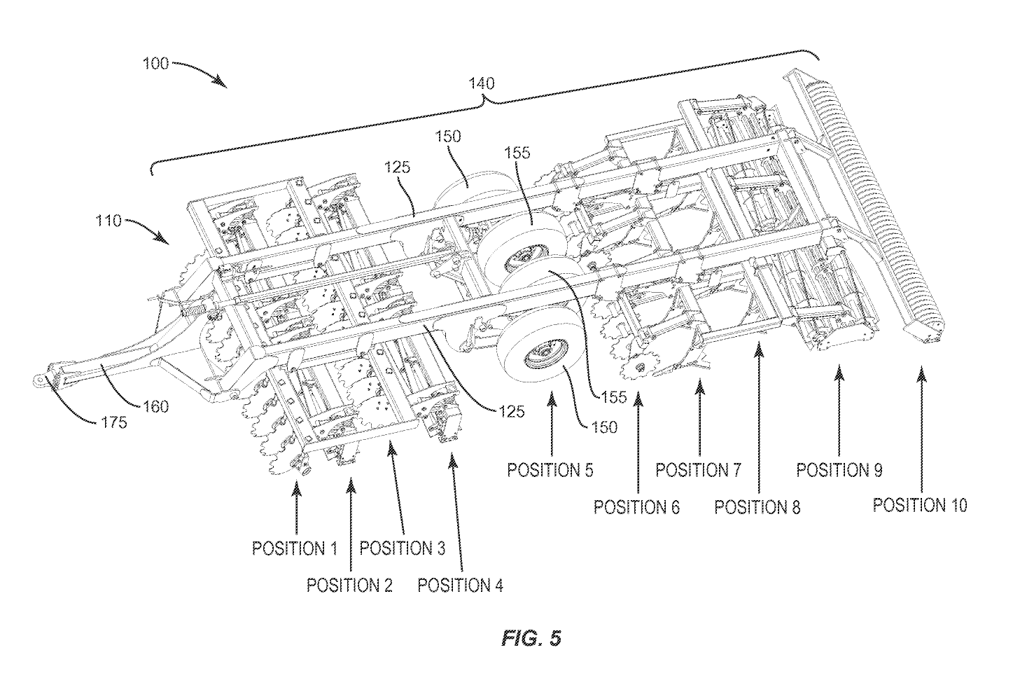

It may be readily apparent to one skilled in the art that the frame assembly 105 may be constructed without movable wings. In various embodiments, the pivotable connections of the left and right frame wings 115, 120 may instead be fixed connections, or the frame assembly 105 may be designed without separate left and right frame wing assemblies 115, 120 as illustrated in FIG. 5 according to various embodiments. The tillage system 100 of FIG. 5 comprises the center frame support structure 110 and the modules 140. However, the left and right frame wings 115, 120 and the front and rear folding frame brackets 130, 135 are absent. The tillage system 100 of FIG. 5 may be used on smaller fields or where it may be desirable or necessary to use a tractor with lower horsepower. The tillage system 100 of FIG. 5 may require a 250 to 450 horsepower tractor, while the tillage system 100 of FIGS. 1 through 4 with left and right frame wings 115, 120 may require a 450 to 750 horsepower tractor. As described below, various embodiments of the tillage system 100 may comprise variations with reduced lengths to accommodate tractors in the 50 to 250 horsepower range.

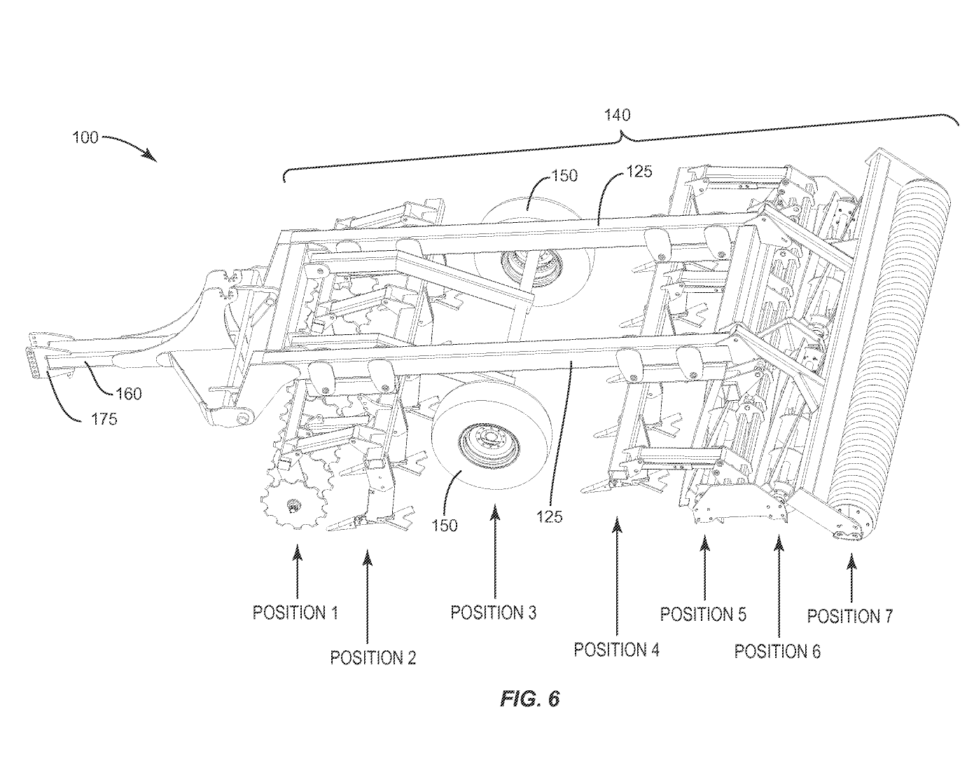

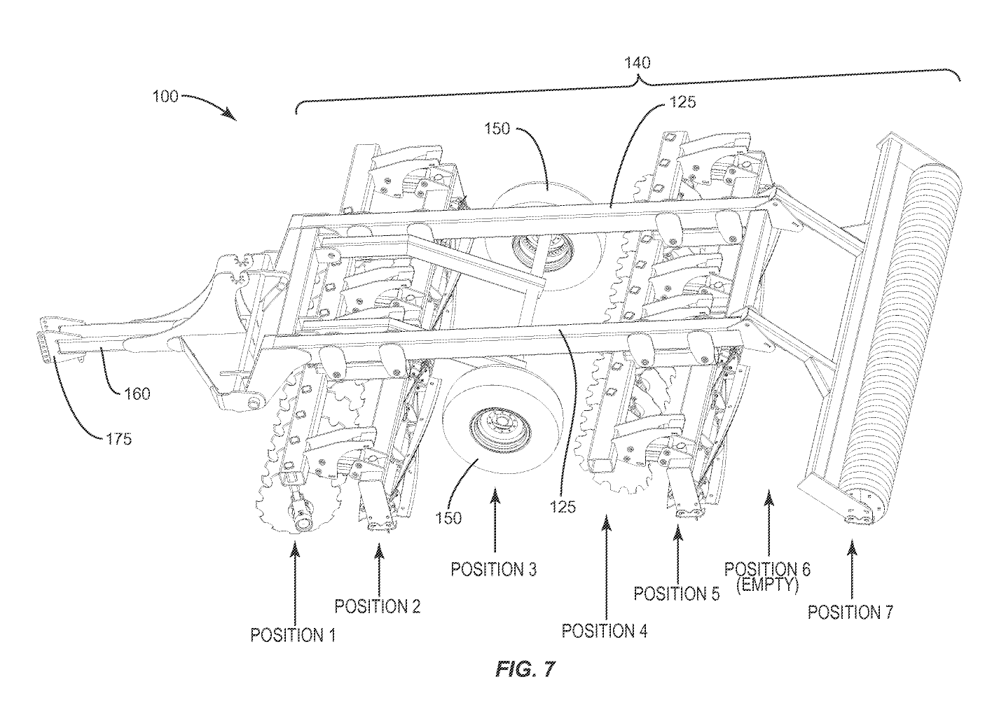

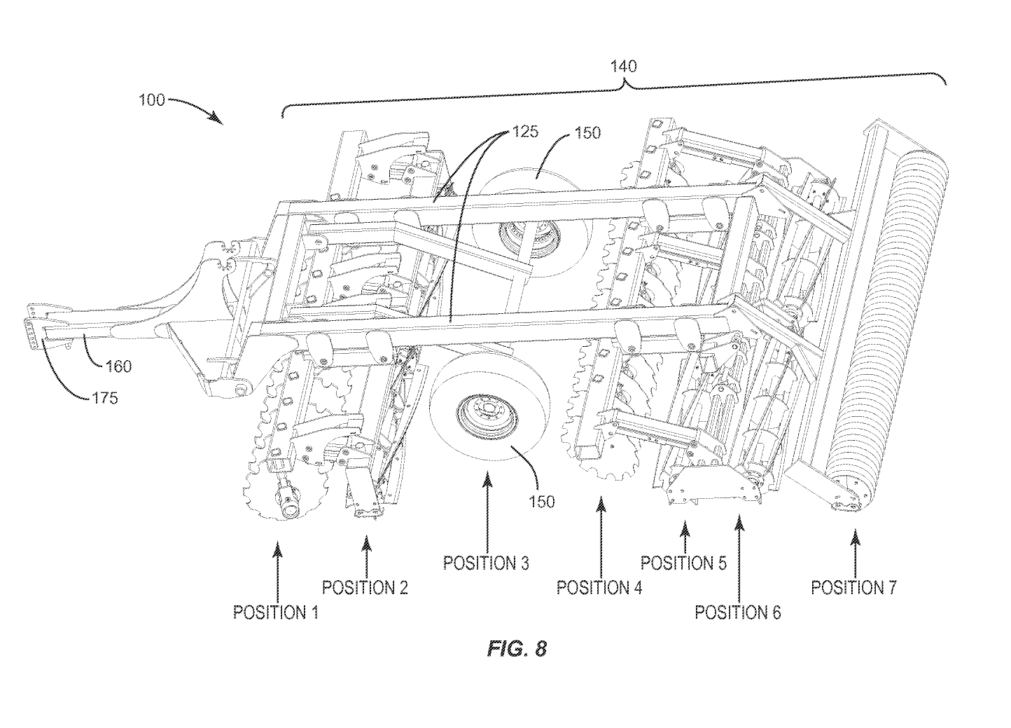

FIG. 6 illustrates various embodiments of the tillage system 100 without left and right frame wings 115, 120. FIG. 6 also illustrates that an overall length of the tillage system 100 may be varied to suit particular tillage needs. For example, the tillage system 100 in FIGS. 1 through 5 may be suitable for open fields where maneuverability may not be a concern. However, in an orchard the available area for making a turn may be limited and a shorter tillage system 100 may facilitate maneuvering around trees. FIG. 6 also illustrates that the number of Positions to mount modules 140 may vary according to various embodiments. Here, the tillage system 100 in FIG. 6 comprises seven Positions. A greater or lesser number of Positions are possible to suit the particular needs of a tillage situation. FIGS. 7 and 8 illustrate the interchangeability of the modules 140 for the tillage system 100 of FIG. 6. In various embodiments, the overall width of the tillage system 100 may vary from about 8 feet to about 20 feet. Similarly, the overall length of the tillage system 100 may be varied to meet specific tillage needs and may vary from about 10 feet to about 50 feet. All embodiments of the tillage system 100, regardless of length, width, or number of positions, may comprise interchangeable modules, the positional order of which may be varied, changed, or adjusted to meet specific tillage requirements.

FIGS. 9 through 16 illustrate exemplary embodiments of modules 140 that may be coupled to the frame assembly 105 of the tillage system 100. One skilled in the art will readily recognize that these illustrations are presented here as examples of configurations that are possible and are not limiting in any way. The modular and interchangeable nature of the tillage system 100 may allow any combination of tillage implements in any desired order.

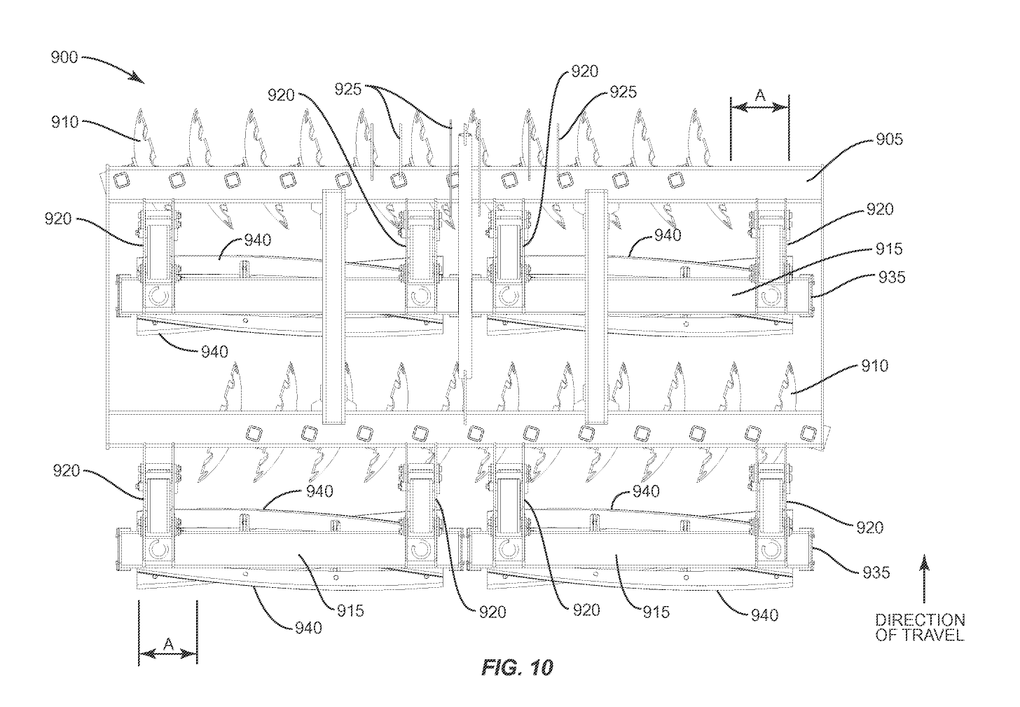

In various embodiments, a plurality of tillage implements or devices may be assembled into a single module 140. Each tillage device may be coupled to a rotating shaft, or may be coupled to the module in a non-rotating configuration. Each tillage device may perform a tillage function to the soil such as cutting, turning, breaking, loosening, moving, contouring, terracing, smoothing, leveling, shattering, bulldozing, pulverizing, mixing, injecting, compacting, and the like. Combining tillage implements may be useful for tillage implements that are commonly used together, such as a disc and reel module 900 of FIGS. 9 and 10. The disc and reel module 900 may comprise a module frame assembly 905 that provides support and a mounting structure for a first row of discs 910, a first row of reels 915, a second row of discs 910, and a second row of reels 915. Each row of discs 910 may comprise a plurality of discs 910 spaced apart across at least a portion of a width of the disc and reel module 900. Each disc 910 may be individually coupled to a rotating disc mounting shaft 930. Each of the reels 915 may comprise a plurality of blades 940 arranged in a generally helical pattern about a rotating reel mounting shaft 935. A plurality of pressure actuators 920 may be mounted between the module frame assembly 905 and the reels 915 to provide a continuous downward force on the reels 915. The pressure actuators 920 may comprise a coil spring, a leaf spring, a hydraulic cylinder, a pneumatic cylinder, or any other device known in the art that is capable of providing a continuous force on the reels 915.

A plurality of coupling arms 925 may be mounted to the module frame assembly 905 and may be adapted to releasably couple the disc and reel module 900 to the tillage system frame assembly 105. The coupling arms 925 may comprise a one or more plates extending upward from a top surface of the module frame assembly 905. The tillage system frame assembly 105 may comprise a similar plurality of plates that may align side-by-side with the coupling arms 925. A lock pin or bolt may be placed through holes in the plates to couple them together. For the purpose of interchangeability, each module 140 may comprise essentially the same coupling arms 925, and each of the Positions on the tillage frame assembly 105 may comprise correspondingly similar mounting plates. One skilled in the art will recognize that any coupling system known in the art may be used to couple the modules 140 to the tillage system frame assembly 105.

Referring to FIG. 10, one of the rows of discs 910 may be angled to the left with respect to the direction of travel (as indicated by the arrow in FIG. 10), and the other row of discs 910 may be angled to the right with respect to the direction of travel. The discs 910 may serve to break up the soil to a certain depth and turn the disturbed soil over. The second row of discs 910 may turn the soil over a second time. As illustrated in FIG. 10, the first row of discs 910 (that is, the row of discs 910 closest to the top of the page) may tend to throw the soil laterally to the right with respect to the direction of travel. This lateral movement of the soil (whether to the right or left of the direction of travel) is referred to generally as soil flow. The row of reels 915 immediately behind the first row of discs 910 may extend from about 6 inches to about 24 inches (as indicated by distance “A” in FIG. 10) beyond the right outermost disc 910 in the direction of throw. When the disc and reel module 900 is traveling at speeds up to and including about 7 miles per hour, the portion of the reel 915 extending beyond the outermost disc 910 may tend to “catch” the soil thrown by the disc 910. This arrangement may control soil flow by prevent clumps of soil from escaping from underneath the disc and reel module 900, thereby allowing the tillage system 100 to leave a more uniformly finished soil surface. The second row of discs 910 may be oriented in an opposite direction than the first row of discs 910, causing the soil to be thrown to the left with respect to the direction of travel. Thus, the row of reels 915 immediately behind the second row of discs 910 may extend beyond the left outermost disc 910 on the second row of discs 910 and function to control soil flow as described above.

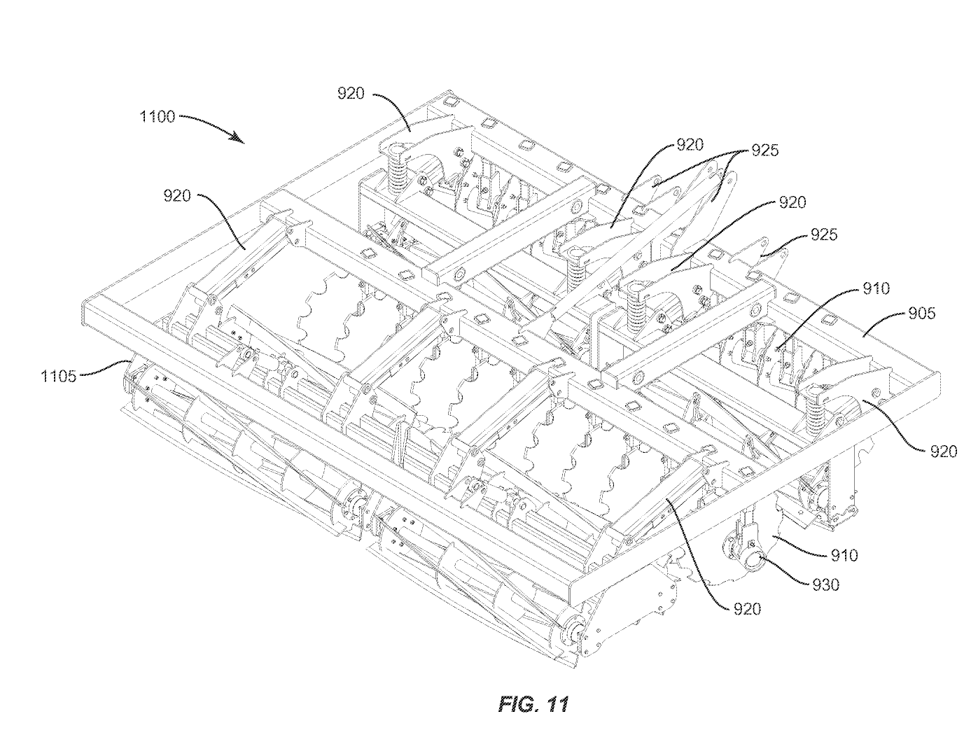

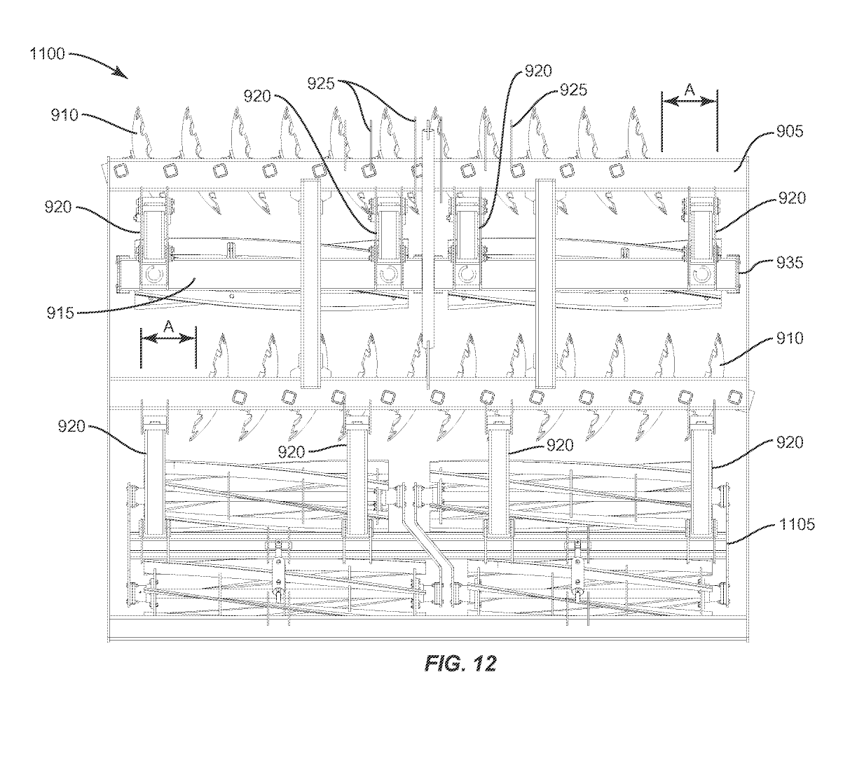

FIGS. 11 and 12 illustrate various embodiments of another combination of tillage implements in a disc, reel, and basket module 1100. The disc, reel, and basket module 1100 may comprise a first row of discs 910 followed by a row of reels 915. The discs 910 and reels 915 may function together as described above. A second row of reels 910 may be positioned behind the reels 915, followed by a row of baskets 1105. The baskets 1105 function similarly to the reels except that the baskets 1105 may provide a greater degree of leveling than the reels. The disc, reel, and basket module 1100 may further comprise actuators 920 to apply a downward force on the reels 915 and baskets 1105. A plurality of coupling arms 925 may be mounted to the module frame 905 as described above.

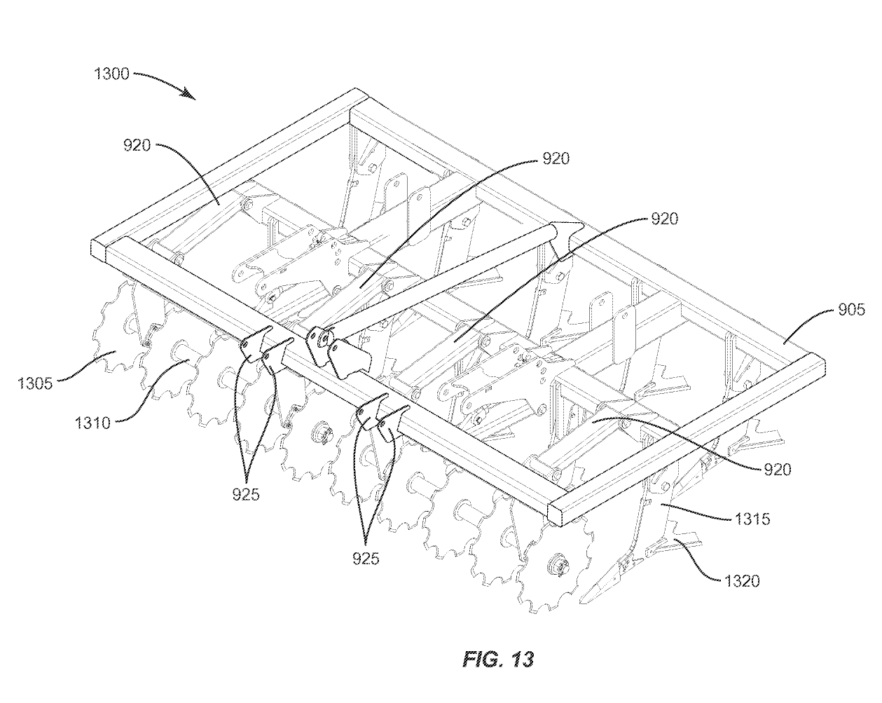

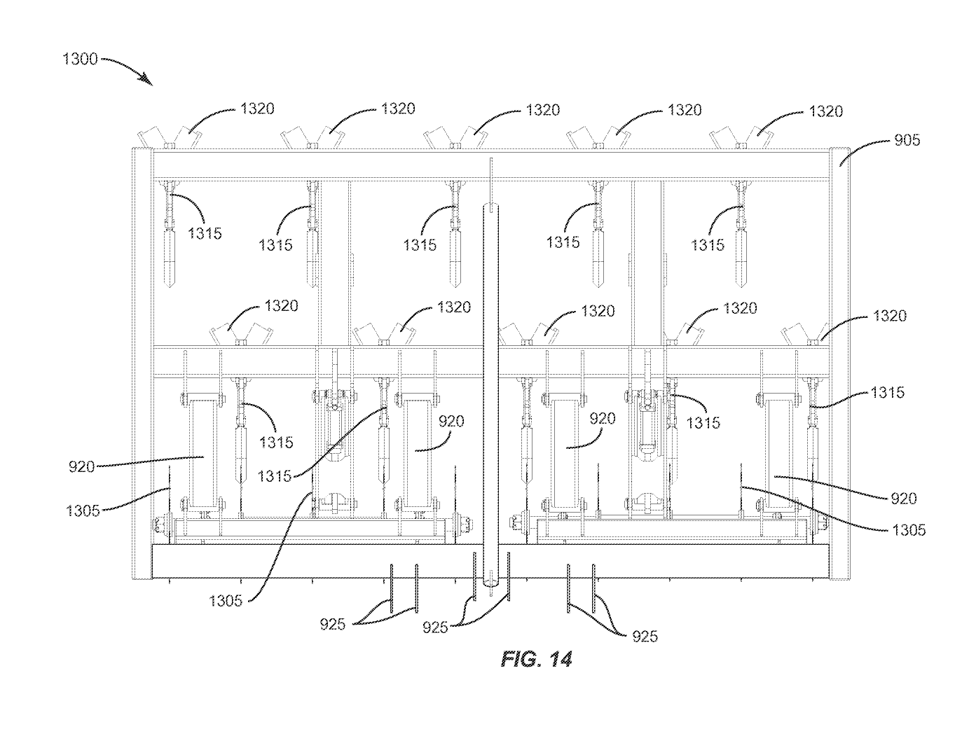

FIGS. 13 and 14 illustrate a coulter and chisel shank module 1300 according to various embodiments. The coulter and chisel shank module 1300 may comprise a module frame assembly 905 that provides support and a mounting structure for a row of coulters 1305 and one or more rows of chisel shanks 1315. The coulters 1305 may comprise generally flat, round blades (as opposed to the bowl-shaped discs 910) spaced apart along a rotating shaft 1310. The chisel shanks 1315 may comprise a curved arm having a first end coupled to the module frame assembly 905 and a second end terminating at a sharpened point positioned to contact the soil. The coulters 1305 may slice and cut the soil to make it easier for the chisel shanks 1315 to penetrate the soil. The chisel shanks 1315 may penetrate a predetermined depth into the soil to break up compacted soil. Actuators 920 may be coupled to the coulters to apply a downward force. The coulter and chisel shank module 1300 may further comprise coupling arms 925 mounted to the module frame assembly 905 as discussed above.

As illustrated in FIG. 13, the chisel shanks 1315 may further comprise a debris flange 1320. The debris flange 1320 may comprise a generally flat V-shaped flange coupled to a back edge of the chisel shank 1315 such that the arms of the “V” extend outward behind the chisel shank (that is, the arms of the “V” extend in the opposite direction from the direction of travel). The debris flange 1320 may be generally parallel to the soil surface when the module 1300 is at rest. The debris flange 1320 may prevent long, flexible material that is present in the soil, such as stems or branches of a plant, from wrapping around the chisel shank 1315.

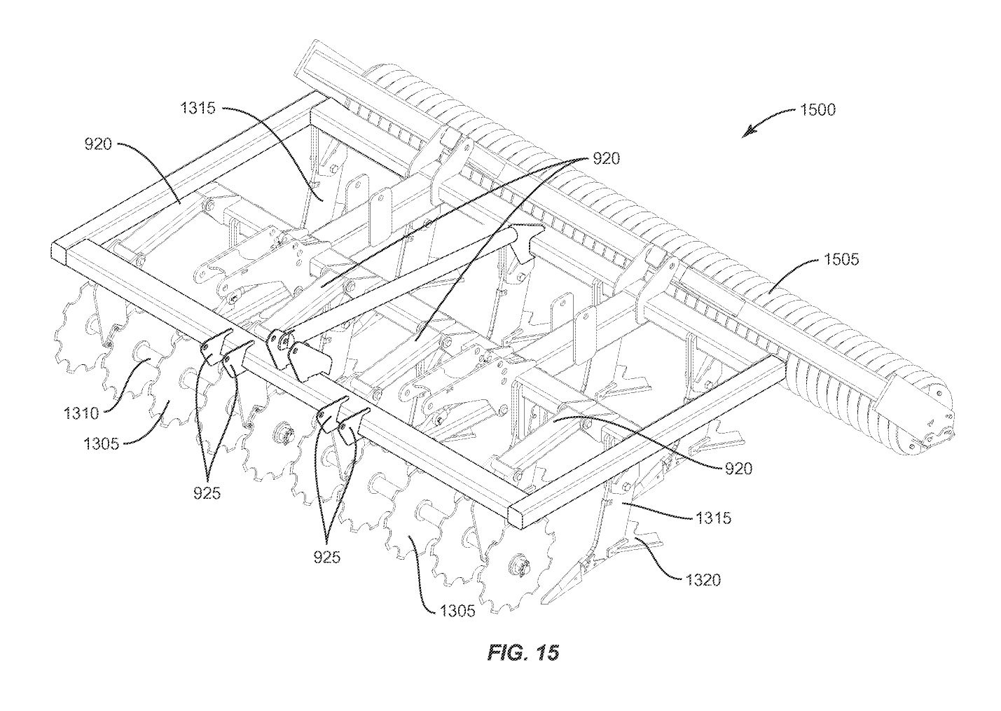

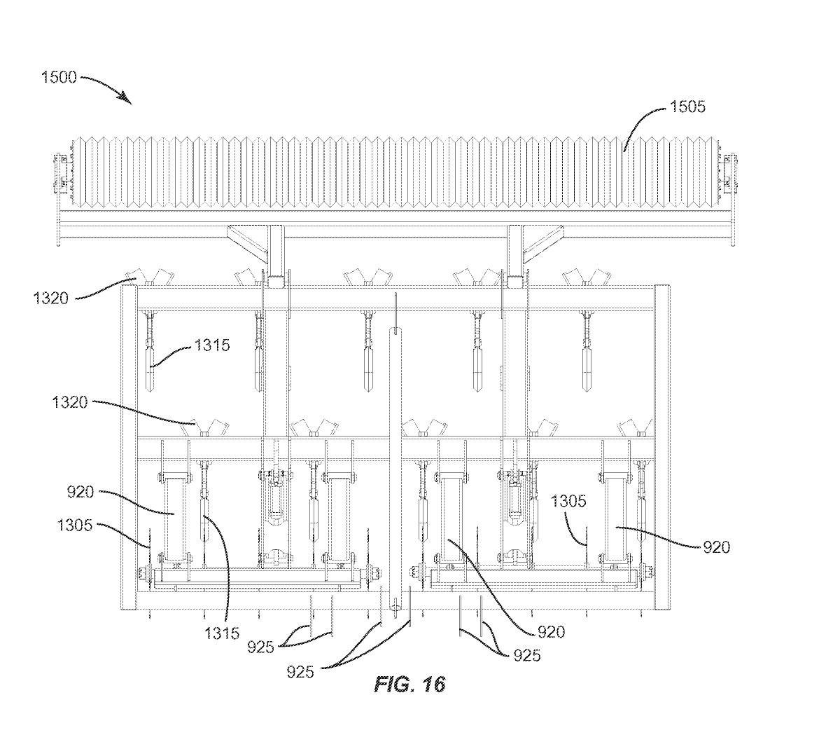

The addition of a roller 1505 to the coulter and chisel shank module 1300 may create a finishing module 1500 as illustrated in FIGS. 15 and 16 according to various embodiments. The finishing module 1500 may (but not exclusively) be mounted at the rear most Position on the tillage system frame assembly 105. The roller 1505 may operate to further break down any remaining clumps of soil and help to seal moisture in the soil. The roller 1505 may also produce a soil surface texture conducive to planting a seed bed.

As discussed previously, the modules illustrated in FIGS. 9 through 16 are non-limiting examples of tillage implements that may be combined into modules. Any other combination of tillage implements is within the scope of the present disclosure, as well as individually coupling the tillage implements to the tillage system frame assembly 105. The order in which the tillage modules or implements are arranged in the tillage system 100 may be predetermined after taking into account a variety of factors or tillage requirements. These factors and requirements may comprise one or more of primary tillage, secondary tillage, intensive tillage, reduced tillage, conservation tillage, seasonal crop rotation tillage, crop-specific tillage, depth-specific tillage, strip tillage, ridge tillage, reservoir tillage, soil moisture content, amount of crop residue in or on the soil, soil erosion characteristics, soil water infiltration rate, soil nutrient content, soil insect content, soil compaction, and the like.

For example, it may be desirable when preparing a field after harvesting to turn the soil once with a row of discs 910 to aerate the soil, and then turn it back over again with a second row of discs 910 in order not to lose an excessive amount of moisture from the soil. However, another situation may occur where vegetation may be growing in the field and it may be desirable to turn the soil over once with a row of discs 910 so that the vegetation is now underground where it can decompose and provide nutrients to the soil.

In another example, a farmer may be making a first pass over the field with a disc implement to turn and break up the soil, a second pass with a chisel shank implement to further break up the soil, a third pass with a reel or basket implement to level the soil and further break up chunks of soil, then a final pass with a roller to texture the surface for later planting. Various embodiments of the tillage system 100, such as the embodiments of FIG. 1, may combine all of these implements and their functions into a single unit that will accomplish the same result in a single pass over the field. This may result in fuel and labor savings of 50 percent or more.

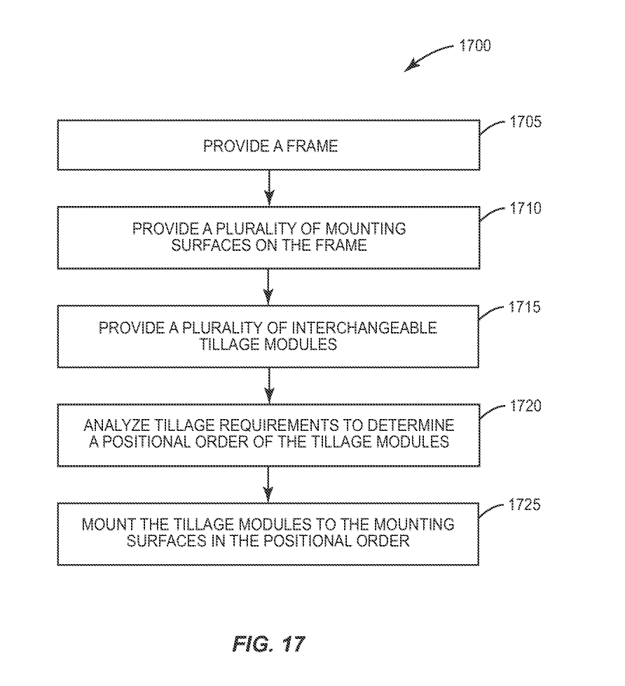

FIG. 17 illustrates a general flow chart of various embodiments of a method 1700 for tilling soil. A frame 105 may be provided (step 1705) to provide structural support. A plurality of mounting surfaces 925 may be provided on the frame 105 (step 1710). The mounting surfaces 925 may comprise a flange extending outward from the frame 105, and a hole may be formed in the flange to accept a locking pin or other fastener or connector. As will be evident to one skilled in the art, any suitable mounting surface 925 known in the art may be provided. At step 1715, a plurality of interchangeable tillage modules 140 may then be provided. Each tillage module 140 may comprise a plurality of tillage implements, or a single tillage implement. Mounting surfaces 925 may also be provided on the tillage modules 140 that are compatible with the mounting surfaces 925 on the frame 105.

At step 1720, tillage requirements may be analyzed to determine a positional order in which the tillage modules 140 may be mounted to the frame 105. The tillage requirements may comprise, for example, one or more of primary tillage, secondary tillage, intensive tillage, reduced tillage, conservation tillage, seasonal crop rotation tillage, crop-specific tillage, depth-specific tillage, strip tillage, ridge tillage, reservoir tillage, soil moisture content, amount of crop residue in or on the soil, soil erosion characteristics, soil water infiltration rate, soil nutrient content, soil insect content, soil compaction, and the like. Once the analysis is complete, the tillage modules may be releasably coupled to the mounting surfaces 925 on the frame 105 in the determined positional order (step 1725).

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A reconfigurable farm implement for tilling soil, comprising:
a frame, the frame comprising a plurality of mounting surfaces; and
a plurality of interchangeable tillage modules releasably coupled to the mounting surfaces and arranged in a predetermined order based on a tillage requirement.

2. The farm implement of claim 1, wherein one or more of the tillage modules comprise from 1 to 5 rotating shafts, each rotating shaft having devices coupled thereon to perform a tillage function.

3. The farm implement of claim 2, wherein the frame is sized to accommodate tillage modules comprising up to 14 rotating shafts.

4. The farm implement of claim 1, wherein one or more of the tillage modules comprise non-rotating devices to perform a tillage function.

5. The farm implement of claim 1, wherein one or more of the tillage modules comprise one or more rotating shafts, each rotating shaft having devices coupled thereon to perform a tillage function, and non-rotating devices to perform a tillage function.

6. The farm implement of claim 1, wherein at least one of the tillage modules comprises a disc module having a plurality of discs spaced apart along a length of the disc module and arranged in one or more rows.

7. The farm implement of claim 1, wherein at least one of the tillage modules comprises a coulter module having one or more rotating shafts with a plurality of coulters spaced apart along an axial length of the shaft.

8. The farm implement of claim 1, wherein at least one of the tillage modules comprises a basket or reel module having one or more rotating shafts with longitudinal blades arranged in a helical pattern around the shaft.

9. The farm implement of claim 1, wherein at least one of the tillage modules comprises a ring roller module having one or more rotating shafts with a plurality of ring rollers positioned along an axial length of the shaft.

10. The farm implement of claim 1, wherein at least one of the tillage modules comprises a chisel shank or tines module having a plurality of chisel shanks or tines arranged in two or more rows.

11. The farm implement of claim 1, wherein at least one of the tillage modules comprises a depth and leveling control module having a first pair of wheels positioned along a first axis and spaced apart from one another along the first axis, and a second pair of wheels positioned along a second axis, the first axis laterally offset from the first axis by a distance less than a diameter of the wheels, and the second pair of wheels positioned within the spaced apart first pair of wheels such that the first and second pair of wheels are capable of independent vertical motion.

12. The farm implement of claim 11, wherein the depth and leveling control module further comprises a leveling system having an adjustable linkage coupled to first and second pair of wheels such that adjusting the linkage causes one or more of the wheels to move vertically to maintain the frame in a substantially level position in response to variable tillage or soil conditions.

13. The farm implement of claim 11, further comprising hydraulic, pneumatic, or electrical actuators coupled to each of the first and second pairs of wheels, wherein the actuators control the height of the frame relative to the ground.

14. The farm implement of claim 10, wherein each chisel shank comprises a curved arm having a first end coupled to the frame, a second end terminating at a sharpened point positioned to contact the soil, and an essentially V-shaped plate coupled to the chisel shank in proximity to the second end such that the sides of the V-shaped plate extend toward a back end of the frame.

15. The farm implement of claim 1, wherein the tillage requirements comprise one or more of primary tillage, secondary tillage, intensive tillage, reduced tillage, conservation tillage, seasonal crop rotation tillage, crop-specific tillage, depth-specific tillage, strip tillage, ridge tillage, reservoir tillage, soil moisture content, amount of crop residue in or on the soil, soil erosion characteristics, soil water infiltration rate, soil nutrient content, soil insect content, and soil compaction.

16. The farm implement of claim 1, wherein the predetermined order of the interchangeable tillage modules is selected at least in part to control soil flow in a lateral direction relative to a direction of travel of the farm implement.

17. The farm implement of claim 16, wherein the farm implement is capable of controlling soil flow at a speed up to and including about 7 miles per hour.

18. The farm implement of claim 1, wherein the frame comprises a center section and left and right sections pivotally coupled to the center section such that the left and right sections are movable between a position essentially parallel to the ground and a position essentially perpendicular to the ground.

19. A reconfigurable farm implement for tilling soil, comprising:
a frame, the frame comprising a plurality of mounting surfaces;
a first interchangeable tillage module releasably coupled to the mounting surfaces comprising a disc module having a plurality of discs spaced apart along a length of the disc module and arranged in one or more rows oriented substantially perpendicular to a direction of travel of the reconfigurable farm implement, the discs operative to penetrate and overturn the soil and move the overturned soil in a lateral direction relative to the direction of travel;
a second interchangeable tillage module releasably coupled to the mounting surfaces comprising a basket or reel module having one or more rotating shafts with longitudinal blades arranged in a helical pattern around the shaft, the blades extending laterally beyond an outermost disc of the disc module such that essentially all of the overturned soil is engaged by the blades to control soil flow in the lateral direction relative to the direction of travel; and
a plurality of additional interchangeable tillage modules releasably coupled to the mounting surfaces and arranged in a predetermined order based on a tillage requirement.

20. The farm implement of claim 19, wherein one or more of the tillage modules comprise from 1 to 5 rotating shafts, each rotating shaft having devices coupled thereon to perform a tillage function.

21. The farm implement of claim 19, wherein one or more of the tillage modules comprise non-rotating devices to perform a tillage function.

22. The farm implement of claim 19, wherein one or more of the tillage modules comprise one or more rotating shafts, each rotating shaft having devices coupled thereon to perform a tillage functions, and non-rotating devices to perform a tillage function.

23. The farm implement of claim 19, wherein the frame is sized to accommodate up to 10 tillage modules.

24. The farm implement of claim 19, wherein at least one of the additional tillage modules comprises a coulter module having one or more rotating shafts with a plurality of coulters spaced apart along an axial length of the shaft.

25. The farm implement of claim 24, further comprising actuators to control a soil penetration depth of the coulters.

26. The farm implement of claim 19, wherein at least one of the additional tillage modules comprises a ring roller module having one or more rotating shafts with a plurality of ring rollers positioned along an axial length of the shaft.

27. The farm implement of claim 19, wherein at least one of the additional tillage modules comprises a chisel shank or tines module having a plurality of chisel shanks or tines arranged in two or more rows.

28. The farm implement of claim 19, wherein the tillage requirements comprise one or more of primary tillage, secondary tillage, intensive tillage, reduced tillage, conservation tillage, seasonal crop rotation tillage, crop-specific tillage, depth-specific tillage, strip tillage, ridge tillage, reservoir tillage, soil moisture content, amount of crop residue in or on the soil, soil erosion characteristics, soil water infiltration rate, soil nutrient content, soil insect content, and soil compaction.

29. The farm implement of claim 19, wherein at least one of the additional tillage modules comprises a depth and leveling control module having a first pair of wheels positioned along a first axis and spaced apart from one another along the first axis, and a second pair of wheels positioned along a second axis, the first axis laterally offset from the first axis by a distance less than a diameter of the wheels, and the second pair of wheels positioned within the spaced apart first pair of wheels such that the first and second pair of wheels are capable of independent vertical motion.

30. The farm implement of claim 29, wherein the depth and leveling control module further comprises a leveling system having an adjustable linkage coupled to the first and second pair of wheels such that adjusting the linkage causes one or more of the wheels to move vertically to maintain the frame in a substantially level position in response to variable tillage or soil conditions.

31. The farm implement of claim 29, further comprising actuators coupled to each of the first and second pairs of wheels, wherein the actuators control the height of the frame relative to the ground.

32. The farm implement of claim 19, wherein the farm implement is capable of controlling soil flow at a speed up to and including about 7 miles per hour.

33. A method for tilling soil, comprising:
providing a frame;
providing a plurality of mounting surfaces on the frame;
providing a plurality of interchangeable tillage modules;
analyzing tillage requirements to determine a positional order of the interchangeable tillage modules; and
mounting the interchangeable tillage modules to the mounting surfaces in the determined positional order.

34. The method of claim 33, wherein one or more of the tillage modules comprise from 1 to 5 rotating shafts, each rotating shaft having devices coupled thereon to perform a tillage function.

35. The method of claim 33, wherein one or more of the tillage modules comprise non-rotating devices to perform a tillage function.

36. The method of claim 33, wherein one or more of the tillage modules comprise one or more rotating shafts, each shaft having devices coupled thereon to perform a tillage function, and non-rotating devices to perform a tillage function.

37. The method of claim 33, wherein at least one of the tillage modules comprises a disc module having a plurality of discs spaced apart along a length of the disc module and arranged in one or more rows.

38. The method of claim 33, wherein at least one of the tillage modules comprises a coulter module having one or more rotating shafts with a plurality of coulters spaced apart along an axial length of the shaft.

39. The method of claim 33, wherein at least one of the tillage modules comprises a basket or reel module having one or more rotating shafts with longitudinal blades arranged in a helical pattern around the shaft.

40. The method of claim 33, wherein at least one of the tillage modules comprises a ring roller module having one or more rotating shafts with a plurality of ring rollers positioned along an axial length of the shaft.

41. The method of claim 33, wherein at least one of the tillage modules comprises a chisel shank or tines module having a plurality of chisel shanks or tines arranged in two or more rows.

42. The method of claim 33, wherein at least one of the tillage modules comprises a depth and leveling control module having a first pair of wheels positioned along a first axis and spaced apart from one another along the first axis, and a second pair of wheels positioned along a second axis, the first axis laterally offset from the first axis by a distance less than a diameter of the wheels, and the second pair of wheels positioned within the spaced apart first pair of wheels such that the first and second pair of wheels are capable of independent vertical motion.

43. The method of claim 42, wherein the depth and leveling control module further comprises a leveling system having an adjustable linkage coupled to first and second pair of wheels such that adjusting the linkage causes one or more of the wheels to move vertically to maintain the frame in a substantially level position in response to variable tillage or soil conditions.

44. The method of claim 42, further comprising hydraulic, pneumatic, or electrical actuators coupled to each of the first and second pairs of wheels, wherein the actuators control the height of the frame relative to the ground.

45. The method of claim 41, wherein each chisel shank comprises a curved arm having a first end coupled to the frame, a second end terminating at a sharpened point positioned to contact the soil, and an essentially V-shaped plate coupled to the chisel shank in proximity to the second end such that the sides of the V-shaped plate extend toward a back end of the frame.

46. The method of claim 33, wherein the tillage requirements comprise one or more of primary tillage, secondary tillage, intensive tillage, reduced tillage, conservation tillage, seasonal crop rotation tillage, crop-specific tillage, depth-specific tillage, strip tillage, ridge tillage, reservoir tillage, soil moisture content, amount of crop residue in or on the soil, soil erosion characteristics, soil water infiltration rate, soil nutrient content, soil insect content, and soil compaction.

47. The method of claim 33, wherein the predetermined order of the interchangeable tillage modules is selected at least in part to control soil flow in a lateral direction relative to a direction of travel of the farm implement.

48. The method of claim 47, wherein the farm implement is capable of controlling soil flow at a speed up to and including about 7 miles per hour.
